(19) United States
(12) Patent Application Publication
(10) Pub. No.: US 2007/0155844 A1
(43) Pub. Date: Jul. 5, 2007

(54) LINKING APPARATUS AND MANUFACTURING METHOD THEREOF

(75) Inventor: Yuan-Fei Zou, Jiang-si Province (CN)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: BENQ CORPORATION, Taoyuan Shien (TW)

(21) Appl. No.: 11/609,925

(22) Filed: Dec. 13, 2006

(30) Foreign Application Priority Data
Dec. 21, 2005 (TW) 94145615

(51) Int. Cl. C08J 9/00

(52) U.S. Cl. 521/77

(57) ABSTRACT

A linking apparatus applied to a disk drive with a transmission component and a reading component is provided. The linking apparatus includes an elastic body and a connecting component. The connecting component is movably connected to the transmission component. A side of the elastic body is connected to the reading component, and the other side of the elastic body is connected to the connecting component. When the transmission component transmits the linking apparatus to indirectly drive the reading component and force the connecting component to deflect, the elastic body restores the connecting component to a stable status. The method of manufacturing a linking apparatus includes the following steps. Firstly, a connecting component is injection-molded. Next, an elastic body is stamped. Lastly, the connecting component is connected to a side of the elastic body.

This application claims the benefit of Taiwan application Serial No. 94145615, filed on Dec. 21, 2005, the subject matter of which is incorporated herein by reference.

### BACKGROUND OF THE INVENTION

1. Field of the Invention

The invention relates in general to a linking apparatus and a manufacturing method thereof, and more particularly to a linking apparatus applied to a disk drive and a manufacturing method thereof.

2. Description of the Related Art

In an age when digital information volume grows rapidly, most multimedia products are issued in the form of an optical disk. With the popularity of optical disks, the optical disk drive which accesses the disk has an increasing demand and plays a critical role in multimedia market nowadays.

Referring to FIG. 1A, a diagram of a conventional disk drive is shown. Conventional disk drive 100 at least includes a transmission component 110, a linking apparatus 120 and a reading component 130. A side of the linking apparatus 120 is connected to the transmission component 110, and the other side of the linking apparatus 120 is connected to the reading component 130. When the transmission component 110 transmits the linking apparatus 120, the reading component 130 is indirectly driven to move. Referring to both FIG. 1A and FIG. 1B, FIG. 1B is a partial 3-D perspective view of a conventional transmission component and a linking apparatus. The linking apparatus 120 is an integrally formed piece of plastic. The linking apparatus 120 has a spring 140 which provides an elastic force enabling the transmission component 110 and the linking apparatus 120 to be firmly connected to each other during the course of movement when the transmission component 110 transmits the linking apparatus 120.

The conventional linking apparatus is an integrally formed piece of plastic. Plastic is a fragile material, so the linking apparatus is likely to be deformed after interacting with the transmission component over a period of time. Consequently, the transmission component and the linking apparatus can not be firmly connected to each other. Moreover, the bending angle on the linking apparatus made from plastic is not precisely formed, and the connection between the linking apparatus and the transmission component is affected when the bending angle is either too large or too small.

### SUMMARY OF THE INVENTION

The invention is directed to a linking apparatus and a manufacturing method thereof. The linking apparatus has an elastic body, and hence does not need any spring or elastic piece. The reading component can be directly fixed on the elastic body. The manufacturing method enables the metal elastic body of the linking apparatus to form a bending angle with higher precision, such that the linking apparatus can be firmly and indirectly connected to the transmission component.

According to a first aspect of the invention, a linking apparatus is provided. The linking apparatus is applied in a disk drive with a transmission component and a reading component. The linking apparatus includes a connecting component and an elastic body. The connecting component is movably connected to the transmission component. A side of the elastic body is connected to the reading component, and the other side of the elastic body is connected to the connecting component.

According to a second aspect of the invention, a disk drive is provided. The disk drive includes a transmission component, a reading component and a linking apparatus. The linking apparatus is connected to the transmission component and includes a connecting component and an elastic body. The connecting component is movably connected to the transmission component. A side of the elastic body is connected to the reading component, and the other side of the elastic body is connected to the connecting component. When the transmission component transmits to drive the linking apparatus, the reading component is moved.

According to a third aspect of the invention, a method of manufacturing a linking apparatus is provided. The linking apparatus is applied in a disk drive with a transmission component and a reading component. The linking apparatus includes the following steps: Firstly, a connecting component movably connected to the transmission component is injection-molded. Next, an elastic body whose one side is connected to the reading component is stamped. Lastly, the connecting component is connected to the other side of the elastic body.

The invention will become apparent from the following detailed description of the preferred but non-limiting embodiments. The following description is made with reference to the accompanying drawings.

### BRIEF DESCRIPTION OF THE DRAWINGS

FIG. 1A (prior art) is a diagram of a conventional disk drive;

FIG. 1B (prior art) is a partial 3-D perspective view of a conventional transmission component and a linking apparatus;

FIG. 2A is a diagram of a disk drive according to a preferred embodiment of the invention;

FIG. 2B is a 3-D perspective view of a linking apparatus according to the preferred embodiment of the invention;

FIG. 2C is a 3-D perspective view of an elastic body with an inverted L-shaped supporting part;

FIG. 2D is a 3-D perspective view of an elastic body with an inverted U-shaped supporting part; and

FIG. 3 is a flowchart of a method of manufacturing a linking apparatus according to a preferred embodiment of the invention.

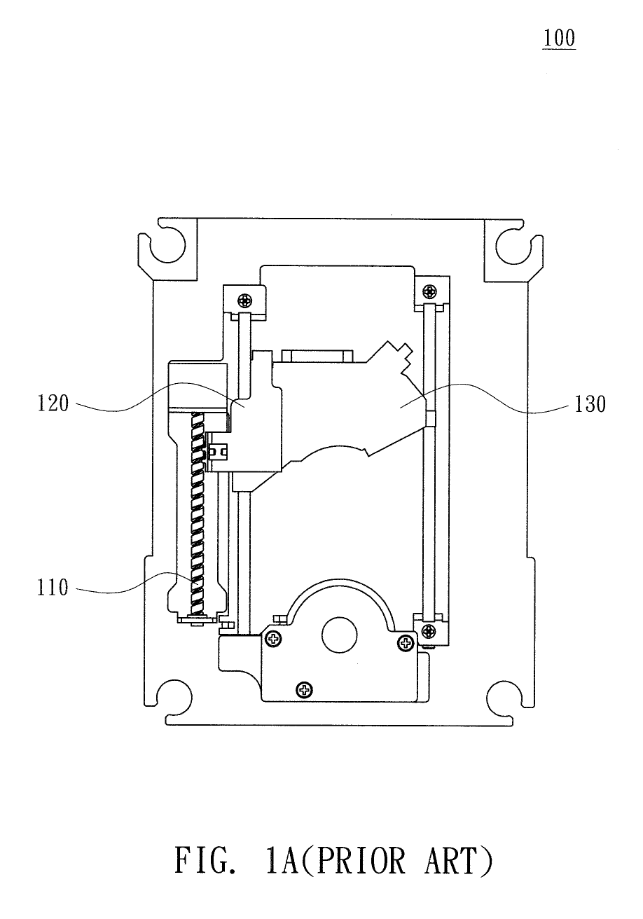

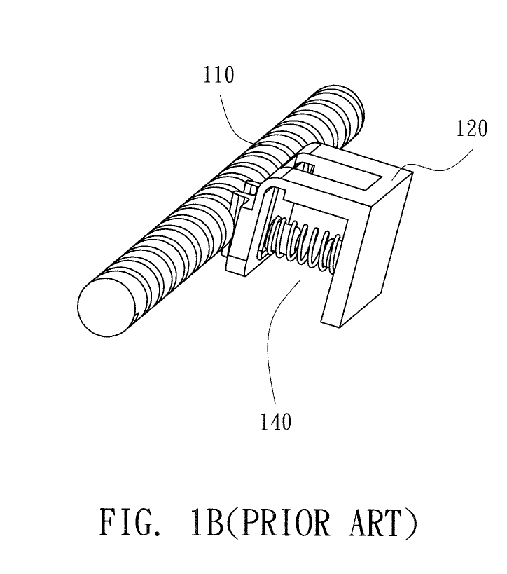

### DETAILED DESCRIPTION OF THE INVENTION

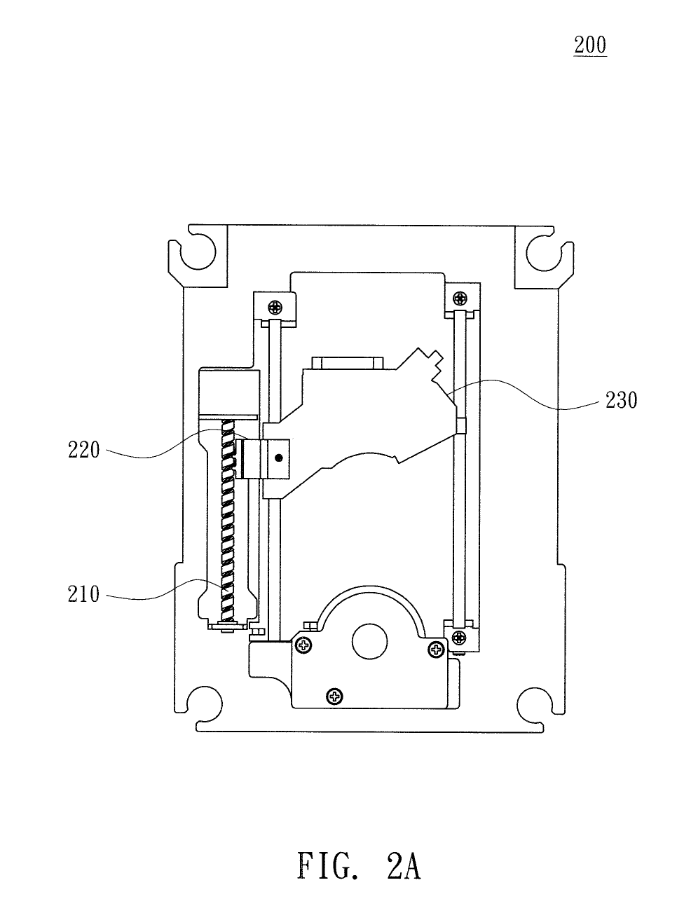

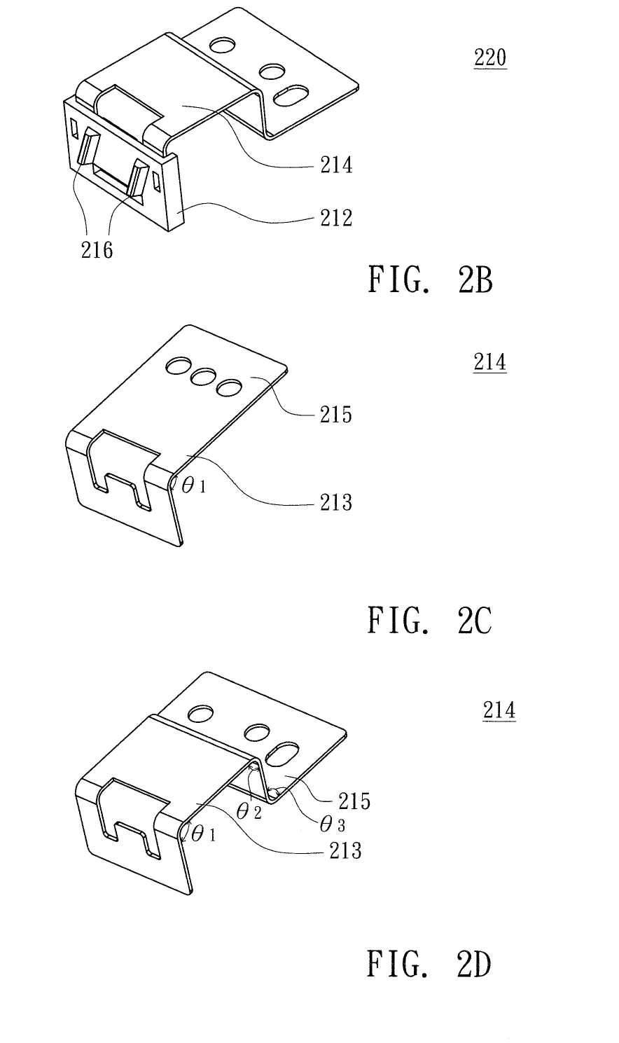

Referring to FIG. 2A, a diagram of a disk drive according to a preferred embodiment of the invention is shown. Also referring to FIG. 2B, a 3-D perspective view of a linking apparatus according to the preferred embodiment of the invention is shown. The disk drive 200 in FIG. 2A at least includes a transmission component 210, a linking apparatus 220 and a reading component 230. As shown in FIG. 2B, the linking apparatus 220 includes a connecting component 212 and an elastic body 214. The connecting component 212 includes an engaging part 216 for engaging with the transmission component 210. Aside of the elastic body 214 is connected to the reading component 230, and the other side of the elastic body 214 is connected to the connecting component 212. The connecting component 212 can be connected to the elastic body 214 by ways of engaging, fusing or adhering. Or, the connecting component 212 is directly injection-molded on the elastic body to be integrally formed in one piece with the elastic body 214. When the transmission component 210 transmits, the transmission component 210 drives the linking apparatus 220 to indirectly drive the reading component 230 and force the connecting component 212 to deflect, such that the elastic body 214 restores the connecting component 212 to a stable status.

A number of elastic bodies are exemplified below. Referring to FIG. 2C and FIG. 2C as well as FIG. 2A and FIG. 2B, FIG. 2C shows a 3-D perspective view of an elastic body with an inverted L-shaped supporting part, FIG. 2D shows a 3-D perspective view of an elastic body with an inverted U-shaped supporting part. As shown in FIG. 2C, the elastic body 214 includes an inverted L-shaped supporting part 213. The supporting part 213 has an elastic bending angle θ1 for providing an elastic force and supporting the connecting component 212 such that the connecting component 212 and the transmission component 210 are firmly connected. Furthermore, a fixing part 215 is extended from the supporting part 213 to fix the reading component 230. In FIG. 2D, the supporting part 213 of the elastic body 214 is an inverted U-shaped structure with three elastic bending angles, θ1, θ2 and θ3. The supporting part 213 and the fixing part 215 contain an elastic bending angle θ3. The three elastic bending angles θ1, θ2 and θ3 provide the supporting part 213 with an elastic force to support the connecting component 212. Besides, the fixing part 215 is extended from the inverted U-shaped structure, and the reading component 230 is fixed on the fixing part 215. The elastic body 214 can be made of stainless steel or iron. The elastic body 214 is capable of providing an elastic force, and does not need any spring or elastic piece to increase elastic force. The elastic body 214 has a fixing part 215 on which the reading component 230 is directly fixed. Therefore, the elastic body 214 not only supports the connecting component 212 but also provides an elastic force and a fixing function

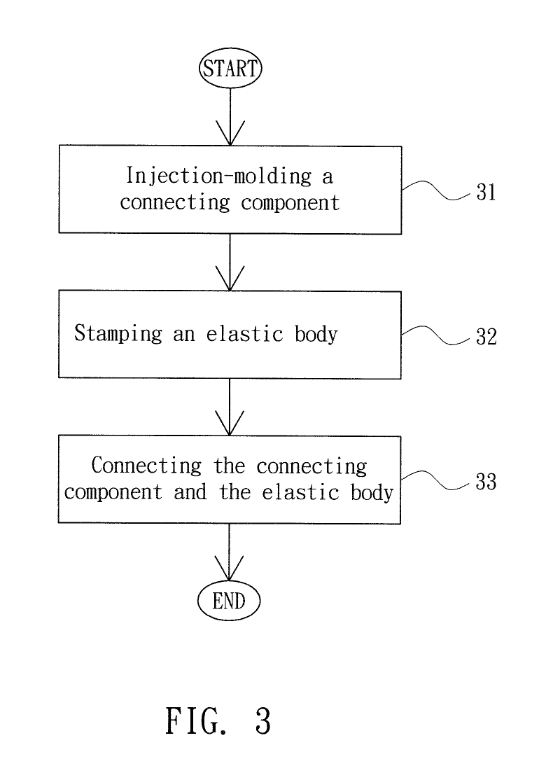

Referring to FIG. 3 as well as FIG. 2A and FIG. 2C, FIG. 3 shows a flowchart of the method of manufacturing a linking apparatus according to a preferred embodiment of the invention. Firstly, the method of manufacturing a linking apparatus begins at step 31, a connecting component 212 movably connected to the transmission component 210 is injection-molded. Next, proceeding to step 32, an elastic body 214 whose one side is connected to the reading component 230 is stamped. Lastly, proceeding to step 33, the connecting component 212 is connected to the other side of the elastic body 214. The connecting component 212 is preferably made of plastic, and the elastic body 214 is preferably made of elastic metal such as stainless steel or iron. The ways of connecting the connecting component 212 and the elastic body 214 include engaging, fusing or adhering. Or, following the stamping step, the connecting component 212 is injection-molded on the elastic body 214, such that the injection-molding step and the connecting step are completed at the same time. The elastic body 214 is manufactured according to stamping process and is illustrated in FIG. 2B. The bending angle θ₁ of the supporting part 213 has higher precision such that the metal elastic body 214 is firmly connected to the transmission component 210, avoiding a failed coupling between the linking apparatus and the transmission component when the bending angle is deflected too wide or too narrow.

According to the linking apparatus and a manufacturing method thereof disclosed in the above embodiment of the invention, the elastic body has an elastic force and is capable of providing the connecting component with a supporting force to restore a stable status without having to install any spring or elastic piece, such that the connecting component is firmly connected to the transmission component. A fixing part is extended from the elastic body, and the reading component is directly fixed on the fixing part. The bending angle of the metal elastic body formed by stamping has higher precision, such that the transmission component can firmly and indirectly drive the reading component to move via the linking apparatus.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A linking apparatus applied to a disk drive with a transmission component and a reading component, the linking apparatus comprising:
a connecting component movably connected to the transmission component; and
an elastic body whose one side is connected to the reading component and the other side is connected to the connecting component;
wherein, when the transmission component transmits the linking apparatus to indirectly drive the reading component and force the connecting component to deflect, the elastic body restores the connecting component to a stable status.

2. The linking apparatus according to claim 1, wherein the elastic body comprises:
a supporting part for providing an elastic force to support the connecting component such that the connecting component and the transmission component are firmly connected; and
a fixing part extended from the supporting part, where in the reading component is fixed on the fixing part.

3. The linking apparatus according to claim 2, wherein the supporting part is an inverted L-shaped structure.

4. The linking apparatus according to claim 2, wherein the supporting part is an inverted U-shaped structure.

5. The linking apparatus according to claim 1, wherein the elastic body is made of stainless steel.

6. The linking apparatus according to claim 1, wherein the elastic body is made of iron.

7. The linking apparatus according to claim 1, wherein the connecting component comprises an engaging part for engaging with the transmission component.

8. The linking apparatus according to claim 1, wherein the connecting component is made of plastic.

9. The linking apparatus according to claim 1, wherein the connecting component is wedged with the elastic body.

10. The linking apparatus according to claim 1, wherein the connecting component is fused to the elastic body.

11. The linking apparatus according to claim 1, wherein the connecting component is adhered to the elastic body.

12. The linking apparatus according to claim 1, wherein the connecting component and the elastic body are integrally formed in one piece by way of an insert injection-molding process.

13. A disk drive, comprising:
a transmission component;
a reading component; and
a linking apparatus connected to the transmission component, the linking apparatus comprising:
a connecting component movably connected to the transmission component; and
an elastic body whose one side is connected to the reading component and the other side is connected to the connecting component;
wherein, the transmission component transmits and drives the linking apparatus to move the reading component.

14 The disk drive according to claim 13, wherein the elastic body comprises:
a supporting part for providing an elastic force to support the connecting component such that the connecting component and the transmission component are firmly connected; and
a fixing part extended from the supporting part, wherein the reading component is fixed on the fixing part.

15. The disk drive according to claim 14, wherein the supporting part is an L-shaped structure.

16. The disk drive according to claim 14, wherein the supporting part is an inverted U-shaped structure.

17. The disk drive according to claim 13, wherein the connecting component comprises an engaging part for enagaging with the transmission component.

18. A method of manufacturing a linking apparatus, wherein the linking apparatus is applied in a disk drive with a transmission component and a reading component, the method comprises the following steps of:
insert injection-molding a connecting component for being movably connected to the transmission component;
stamping an elastic body whose one side is connected to the reading component; and
connecting the connecting component to the other side of the elastic body.

19. The method of manufacturing a linking apparatus according to claim 18, wherein the connecting step comprises:
wedging the connecting component with the elastic body.

20. The method of manufacturing a linking apparatus according to claim 18, wherein the connecting step comprises:
fusing the connecting component to the elastic body.

21. The method of manufacturing a linking apparatus according to claim 18, wherein the connecting step comprises:
adhering the connecting component to the elastic body.

22. The method of manufacturing a linking apparatus according to claim 18, wherein following the stamping step, the connecting component is directly insert injection-molded on the elastic body, such that the insert injection-molding step and the connecting step are completed at the same time.
